(19) United States
(12) Patent Application Publication
(10) Pub. No.: US 2023/0016277 A1
(43) Pub. Date: Jan. 19, 2023

(54) System, Method, and Computer Program Product for Avoiding Ground Blindness in a Vehicle

(71) Applicant: OUTSIGHT, Paris (FR)

(72) Inventor: Raul Bravo Orellana, Paris (FR)

(21) Appl. No.: 17/797,471

(22) PCT Filed: Jan. 29, 2021
(86) PCT No.: PCT/EP2021/052172

§ 371 Date: Aug. 4, 2022

Related U.S. Application Data
(60) Provisional application No. 62/970,398, filed on Feb. 5, 2020.

(51) Int. Cl. G06V 20/56; G06T 7/70

(52) U.S. Cl. CPC G06V 20/56; G06T 7/70; G06T 2207/30252

(57) ABSTRACT

Provided is a method, system, and computer program product for avoiding ground blindness in a vehicle. The method includes capturing, with a detection device, a plurality of frames of three-dimensional data over a time period while the vehicle is approaching a landing zone, the plurality of frames of three-dimensional data representing a region associated with the landing zone, generating a rolling point cloud map for the region by combining, with at least one processor during the time period, a subset of the plurality of frames, determining, with the at least one processor, a ground blindness event occurring in the region during the time period, in response to determining the blindness event occurring in the region, excluding at least one frame from the subset of the plurality of frames used to generate the rolling point cloud map for the region, determining, with at least one processor, position data representing a position of the vehicle based on at least one sensor, and generating, with the at least one processor, an output based on the rolling point cloud map and the position data.

### BACKGROUND

### 1. Field

This disclosure relates generally to vehicles and, in non-limiting embodiments, systems, methods, and computer products for avoiding ground blindness in a vehicle.

### 2. Technical Consideration

Pilots of vehicles may encounter situations in which a ground blindness event, such as a brownout or whiteout, obscures the visibility of a region. Existing techniques for navigating through a ground blindness event include using sensors such as a Global Position System (GPS) and/or Inertial Measurement Unit (IMU). However, such sensors only provide height or position information and do not provide any relevant information regarding the shape or contour of a region or any obstacles, such as holes, trees, rocks, or the like, that may prevent landing in the region. This poses a significant safety risk to the pilot and potential damage to the vehicle.

### SUMMARY

According to non-limiting embodiments or aspects, provided is a method for avoiding ground blindness in a vehicle, including: capturing, with a detection device, a plurality of frames of three-dimensional data over a time period while the vehicle is approaching a landing zone, the plurality of frames of three-dimensional data representing a region associated with the landing zone; generating a rolling point cloud map for the region by combining, with at least one processor during the time period, a subset of the plurality of frames; determining, with the at least one processor, a ground blindness event occurring in the region during the time period; in response to determining the blindness event occurring in the region, excluding at least one frame from the subset of the plurality of frames used to generate the rolling point cloud map for the region; determining, with at least one processor, position data representing a position of the vehicle based on at least one sensor; and generating, with the at least one processor, an output based on the rolling point cloud map and the position data.

According to another non-limiting embodiment, provided is a method for avoiding ground blindness in a vehicle, including: capturing, with a detection device, a plurality of frames of three-dimensional data over a time period while the vehicle is approaching a landing zone, the plurality of frames of three-dimensional data representing a region associated with the landing zone; generating, with at least one processor, a rolling point cloud map for the region by combining, with at least one processor during the time period, a subset of the plurality of frames; determining, with at least one processor, a ground blindness event occurring in the region during the time period; in response to determining the ground blindness event occurring in the region, determining a position of the vehicle; and generating, with at least one processor, at least one frame based on the position of the vehicle and at least one other frame of the plurality of frames.

According to another non-limiting embodiment, provided is a system for avoiding ground blindness in a vehicle, including: a detection device arranged on the vehicle, the detection device configured to capture a plurality of frames of three-dimensional data over a time period while the vehicle is approaching a landing zone, the plurality of frames of three-dimensional data representing a region associated with the landing zone; and at least one processor in communication with the detection device, the at least one processor programmed or configured to: generate a rolling point cloud map for the region by combining, with at least one processor during the time period, a subset of the plurality of frames; determine a ground blindness event occurring in the region during the time period; in response to determining the ground blindness event occurring in the region, determine a position of the vehicle; and generate at least one frame based on the position of the vehicle and at least one other frame of the plurality of frames.

According to a further non-limiting embodiment, provided is a computer-program product for avoiding ground blindness in a vehicle, comprising at least one non-transitory computer-readable medium including program instructions that, when executed by at least one processor, cause the at least one processor to: capture a plurality of frames of three-dimensional data over a time period while the vehicle is approaching a landing zone, the plurality of frames of three-dimensional data representing a region associated with the landing zone; generate a rolling point cloud map for the region by combining, with at least one processor during the time period, a subset of the plurality of frames; determine a ground blindness event occurring in the region during the time period; in response to determining the ground blindness event occurring in the region, determine a position of the vehicle; and generate at least one frame based on the position of the vehicle and at least one other frame of the plurality of frames.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for avoiding ground blindness in a vehicle according to non-limiting embodiments;

FIG. 2A is an illustration of a vehicle approaching a landing zone according to non-limiting embodiments;

FIG. 2B is another illustration of a vehicle approaching a landing zone according to non-limiting embodiments;

FIG. 3 is a further illustration of a vehicle approaching a landing zone according to non-limiting embodiments;

FIG. 4 is a flow diagram for a method for avoiding ground blindness in a vehicle according to non-limiting embodiments; and

FIG. 5 illustrates example components of a device used in connection with non-limiting embodiments.

### DESCRIPTION OF THE PREFERRED EMBODIMENTS

For purposes of the description hereinafter, No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data, such as a processor (e.g., a CPU, a microcontroller, and/or any other data processor). A computing device may, in some examples, include the necessary components to receive, process, and output data, such as a display, a processor, a memory, an input device, and a network interface. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may also be a desktop computer or other form of non-mobile computer.

As used herein, the term “server” may refer to or include one or more computing devices that are operated by or facilitate communication and/or processing for multiple parties in a network environment, such as the Internet, although it will be appreciated that communication may be facilitated over one or more public or private network environments and that various other arrangements are possible. Further, multiple computing devices (e.g., servers, other computing devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “aerial vehicle” refers to one or more vehicles that travel through the air, such as a helicopter, drone system, flying taxi, airplane, glider, jet, and/or the like. An aerial vehicle may include, for example, vehicles with vertical take-off and landing, vehicles with short take-off and landing, and/or any other vehicles configured to approach a landing zone on a physical surface from the air.

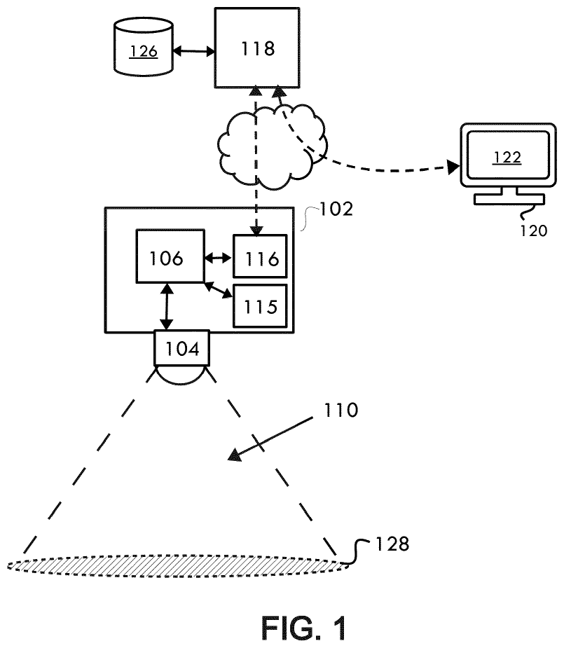

Referring now to FIG. 1, a system 1000 for avoiding ground blindness is shown according to a non-limiting embodiment. FIG. 1 illustrates a vehicle 102 having a three-dimensional detection device 104. In non-limiting embodiments, the three-dimensional detection device 104 may be a LiDAR device, RADAR device, and/or any other device configured to generate three-dimensional data from a field-of-view 110. The field-of-view 110 may be the range of detection of the three-dimensional detection device 104 within which three-dimensional data, such as point cloud data, is captured from surfaces (e.g., objects, buildings, entities, ground surfaces, foliage, aerial cables, and/or the like) located in the field-of-view 110. The field-of-view 110 of the detection device 104 may vary depending on the arrangement of the detection device 104. In the depicted example, the vehicle 102 is approaching a landing zone 128 on a surface (e.g., a ground surface, a roof of a building, and/or the like).

With continued reference to FIG. 1, in non-limiting embodiments the vehicle 102 may include a computing device 106. The computing device 106 may be arranged in the vehicle 102 (e.g., within the vehicle 102, attached to the vehicle 102, and/or the like). In some non-limiting embodiments, the computing device 106 may include a first computing device arranged in the vehicle (such as an on-board controller) and a second computing device arranged in the three-dimensional detection device 104 (e.g., such as one or more processors dedicated to the three-dimensional detection device 104). In non-limiting embodiments, the vehicle also includes one or more sensors 115 configured to measure the position of the vehicle 102, such as an Inertial Measurement Unit (IMU), accelerometer, gyroscope, Global Positioning System (GPS), altimeter, and/or the like. The position of the vehicle 102 may be determined from an absolute position of the vehicle 102 and/or a relative position (e.g., displacement) based on movement of the vehicle. The sensor 115 may be in communication with the computing device 106 and may communicate captured position data to the computing device 106. The position data communicated to the computing device 106 may be unprocessed sensor data or, in other examples, may be processed by a processor local to the sensor 115 (not shown in FIG. 1) before being communicated to the computing device 106.

Still referring to FIG. 1, the three-dimensional detection device 104 may capture a plurality of frames of three-dimensional data as it approaches a destination (e.g., such as the landing zone 128). Each frame may include point cloud data representing three-dimensional coordinates of reflecting surfaces (e.g., including portions of the landing zone 128 and/or any objects) within the field-of-view 110 at a particular time and within a three-dimensional space. As the vehicle 102 moves, successive frames are captured by the three-dimensional detection device 104 to obtain numerous frames of point cloud data representing the reflecting surfaces within the field-of-view 110. For example, the point cloud data may represent different portions of the same object and/or landing zone. The point cloud data from each frame may be combined by the computing device 106 to generate a reference map on a rolling basis (e.g., a rolling map). The reference map can be “rolling” in a temporal sense and/or spatial sense. For example, the rolling map can be generated by integrating point cloud data from a plurality of recent frames in a certain window of time. In non-limiting embodiments, new frame data is combined into the reference map for a certain period of time and discarded from the reference map after that period of time. Alternatively, the rolling map can be generated by integrating point cloud data from a plurality of frames within a field-of-view or within a volume. In other words, frame data is combined in the reference map in the field of view of the volume. When the field of view or volume changes, In non-limiting embodiments, the point cloud data may be combined by overlaying the points from each of the plurality of frames into a single frame. For example, the points from a first frame may be combined with the points from one of more subsequent frames, thereby increasing the number of points for a given surface and/or portion of a surface by accumulating points from multiple frames.

In non-limiting embodiments, the reference map may be generated using a Simultaneous Localization and Mapping (SLAM) algorithm. The SLAM algorithm may be used to determine the pose and orientation of the three-dimensional detection device 104 in each frame while building the rolling map. In non-limiting embodiments, a registration process can be used by using pose and orientation data from one or more one or more sensors 115. In non-limiting embodiments, the reference map may be generated using a probabilistic data fusion algorithm (e.g. Kalman filters) to combine the point cloud data from multiple frames and data one or more sensor 115. In non-limiting embodiments, the reference map may be generated using time stamps associated with each frame and the position and/or orientation of the three-dimensional detection device 104 when each frame was captured. The reference map may include any number of combined frames which may or may not be successive. For example, approximately ten frames may be used in some examples while, in other examples, hundreds or thousands of frames may be combined to form a reference map. In non-limiting embodiments, approximately one hundred or more frames may be used if the frames are captured at low speeds and one thousand or more frames may be used if the frames are captured at high speeds (e.g., from a moving vehicle). For example, for a LiDAR device operating at 30 Hertz, 5 to 30 seconds of data history may be represented by the reference map. The reference map may be continually generated by the computing device 106 based on point cloud data obtained from new frames captured over time. For example, new frames captured while the vehicle 102 is moving or stationary may be captured and used to generate the reference map. In non-limiting embodiments, the reference map may be continually generated in real time as the new frames are captured by the three-dimensional detection device 104.

Still referring to FIG. 1, in non-limiting embodiments the vehicle 102 may include a communication device 116 to facilitate communication between the computing device 106 and a remote computing device 118, such as a server computer. The communication device 116 may include any device capable of communicating data to and from a remote computing device 118 such as, for example, a cellular or satellite transceiver. The computing device 106 may communicate the generated reference map to the remote computing device 118 using the communication device 116. In some non-limiting embodiments, the computing device 106 may communicate individual frames to the remote computing device 118 such that the remote computing device 118 generates the reference map based on the frames.

With continued reference to FIG. 1, the remote computing device 118 may be in communication with a data storage device 126 and may store the reference map and/or individual frames in one or more data structures within the data storage device 126. The remote computing device 118 may be in communication with a user-operated computing device 120 including a display device 122. The remote computing device 120 may display the reference map or visualizations derived from the reference map on the display device 122. For example, the user-operated computing device 120 may be operated by a pilot of an unmanned vehicle for controlling the vehicle.

Still referring to FIG. 1, during movement of the vehicle 102 toward the landing zone 128, a plurality of successive frames may be captured and combined to provide a visualization of the landing zone 128 for use by an operator. The vehicle 102 may approach the landing zone 128 to land and/or to drop off a package or passenger, as an example. During this approach, a ground blindness event may occur. The term “ground blindness event,” as used herein, refers to one or more occurrences that at least partially obscure the landing zone 128 from visibility (e.g., by a human and/or a sensor). A ground blindness event may include, for example, a brownout (e.g., a limitation on visibility due to airborne dust, dirt, sand, smoke, and/or other particulate matter) or a whiteout (e.g., a limitation on visibility due to snow, sand, and/or other material covering the contours and/or features of a region). As an example, a ground vehicle, another vehicle, or the vehicle 102 itself (e.g., such as the blades of a helicopter or drone) may agitate loose particulate matter on the ground and cause a brownout to occur at any point during the approach of the vehicle 102. As another example, during the approach of the vehicle 102, snow or sand may drift over a landing zone 128 or nearby features to cause a whiteout to occur at any point during the approach of the vehicle 102.

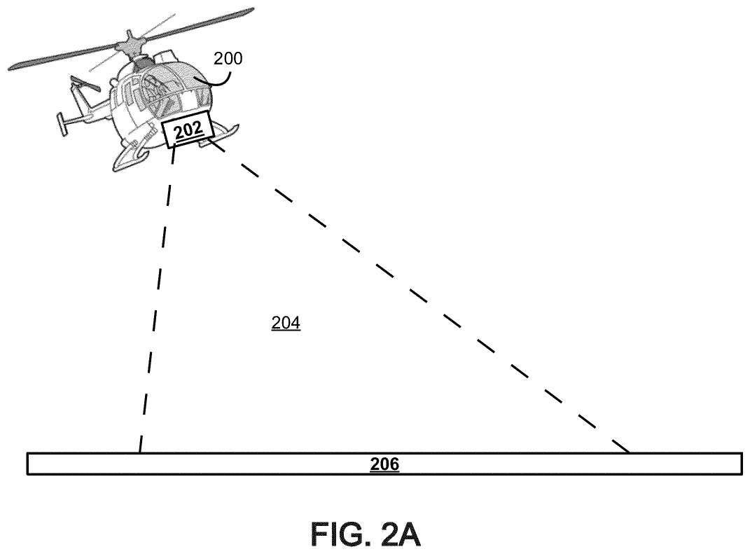

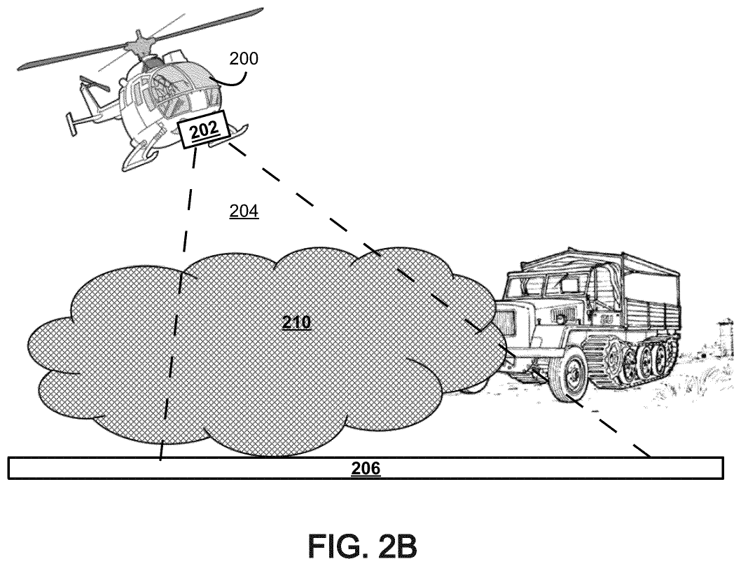

Referring now to FIGS. 2A and 2B, an aerial vehicle 200 is shown approaching a landing zone 206 (e.g., a portion of a surface such as the ground). A detection device 202 configured to generate three-dimensional data captures frames of three-dimensional data in the field-of-view 204, including three-dimensional data representing the landing zone 206. In FIG. 2A, the detection device 202 has a clear view of the landing zone 206 and captures accurate frames of three-dimensional data representative of the landing zone 206 and any objects between. In FIG. 2B, a brownout on or near the landing zone 206 is caused by a cloud 210 of dust formed from an approaching land vehicle. In this example, the detection device 202 does not have a clear view of the landing zone 206 and cannot capture accurate frames of three-dimensional data representative of the landing zone 206. For example, laser beams emitted by a LiDAR device may not all reach the landing zone 206 because they reflect off particulate matter in the cloud 210 or, for those beams that do reach the landing zone surface, may not reflect back to the LiDAR device because of the particular matter in the cloud 210.

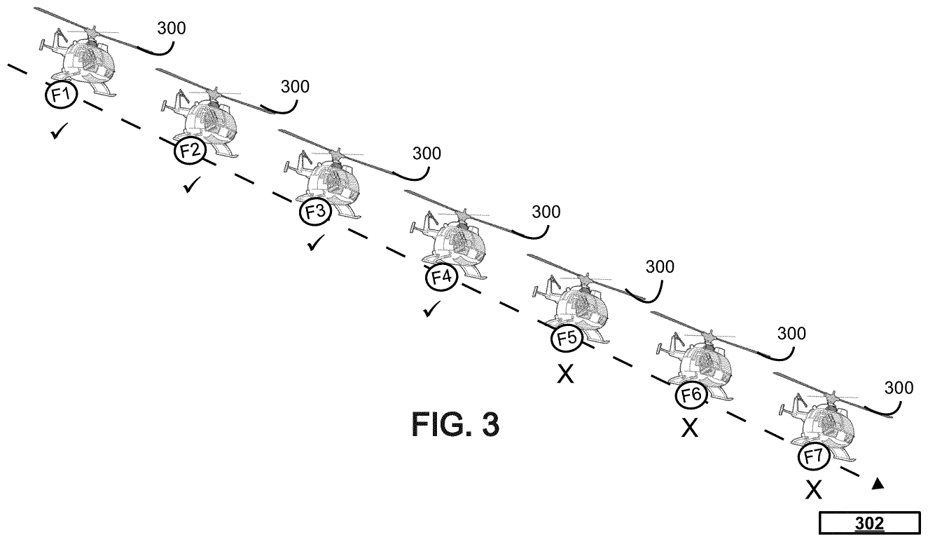

Referring now to FIG. 3, an aerial vehicle 300 is shown approaching a landing zone 302. At several points during the approach of the vehicle 300, frames F1, F2, F3, F4, F5, F6, and F7 of three-dimensional data are captured by a detection device arranged on the vehicle 300. It will be appreciated that any number of frames may be captured at any rate. In the depicted example, a ground blindness event occurs between the capture of frame F4 and frame F5, such that frame F4 is an accurate representation of the landing zone but frame F5 is not. The ground blindness event may be automatically detected or, in other examples, an operator may provide an input to indicate that the ground blindness event is occurring. In non-limiting embodiments, in response to determining that the ground blindness event is occurring, frame F5, F6, and F7 may be excluded from the reference map being constructed of the landing zone during approach of the vehicle 300. In non-limiting embodiments, in response to determining that the ground blindness event is occurring, position data may be captured by one or more sensors arranged on the vehicle 300 such that one or more frames may be generated (e.g., reconstructed based on available data and/or interpolated into a sequence of frames based on the other frames) and/or an output representation of the landing zone may be adjusted without using three-dimensional data from frames F5, F6, and F7.

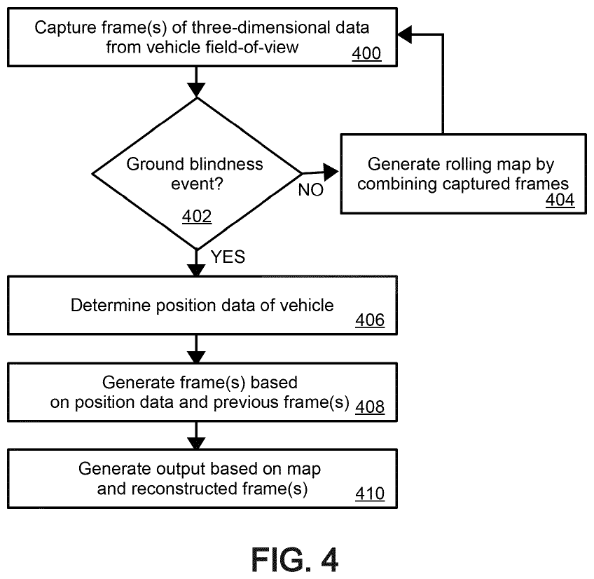

Referring to FIG. 4, a flow diagram is shown according to a non-limiting embodiment. It will be appreciated that the steps and order of steps in FIG. 4 are for example purposes only and that the method may be performed with additional steps, fewer steps, and/or a different order of steps. At a first step 400, a field-of-view is scanned with a three-dimensional detection device, such as a LiDAR device, to capture one or more frames of three-dimensional data. In some examples, the scan generates a frame of point cloud data representative of the field-of-view. This process may be repeated to obtain multiple frames of point cloud data. At a next step 402, it is determined if a ground blindness event has occurred. A ground blindness event may be determined based on a manual user input, such as a user pressing a button or issuing a command in response to viewing the ground blindness event. In other examples, a ground blindness event may be determined automatically based on one or more algorithms. For example, it may be determined if a number of received signals satisfies a threshold (e.g., is greater than, less than, and/or equal to a threshold value), if a change in point cloud data for a received frame compared to one or more previous frames satisfies a threshold, and/or the like. In non-limiting embodiments, when a ground blindness event is determined, a navigation system associated with the vehicle may switch to a low visibility (e.g., degraded signal) mode.

With continued reference to FIG. 4, if a ground blindness event does not occur at step 402, the method proceeds to step 404 in which a rolling map is generated by combining multiple frames of three-dimensional data. For example, the latest captured frame(s) from the detection device may be incorporated into a rolling point cloud map that is generated based on several previously-captured frames of three-dimensional data. The frame of point cloud data is processed with point cloud data from previously received frames from previous scans to correlate the point cloud data. The method may then continue back to step 400 such that one or more additional frames of three-dimensional data are captured. If a ground blindness event does occur at step 402, the method may proceed to step 406 in which position data of the vehicle is determined. Position data and/or sensor data from which position data can be determined for the vehicle may be collected and stored throughout the entire method and/or concurrent with any steps 400, 402, 404, 406, 408, and/or 410. For example, GPS data, motion data, orientation data, and/or other sensor data may be collected and used to determine a relative or absolute position of the vehicle, including the spatial position, orientation position, relative position with respect to an object or marking, and/or the like.

With continued reference to FIG. 4, at step 408, one or more frames are generated based on the position data and one or more previously-captured frames. For example, in response to determining that a ground blindness event occurred at step 402 and/or in response to determining position data of the vehicle during the ground blindness event, the previously-captured frames may be analyzed to generate a new frame (e.g., a reconstructed frame) from a captured frame that is partially or fully obscured due to a ground blindness event. The position data may be used, for example, to adjust the perspective and/or orientation of the field-of-view of the generated frame based on previously-captured frames and a positional displacement between the position data captured at the time of the obscured frame and previous position data associated with captured frames of unobscured three-dimensional data. In some non-limiting embodiments, the response to a ground blindness event may be a function of a measure of signal degradation or loss. For example, if the signal is degraded in a localized region of a landing zone, only the three-dimensional data in the degraded region may need to be corrected (e.g., reconstructed). In non-limiting embodiments, new frames or portions of new frames (e.g., reconstructed portions) may be generated based on one or more machine learning algorithms. The generated frames and captured frames may be input into such machine learning algorithms for training to improve future iterations.

Still referring to FIG. 4, at step 410 an output is generated based on the rolling map generated at step 404 and the one or more reconstructed frame(s) generated at step 408. The output may include, for example, an updated rolling map, a visual representation of the landing zone on a display device, a command to an automated system controlling the vehicle, a command to an operator of the vehicle, and/or the like.

In non-limiting embodiments, the system can apply a ponderation based on the estimated signal quality. The ponderation can be applied to other sensors, such as a camera. The ponderation can be used to remove noisy data that would otherwise be processed by algorithms (e.g., landing assistance system using machine learning algorithm to process a video feed).

Although the examples shown in FIGS. 2A, 2B, and 3 show an aerial vehicle, non-limiting embodiments may be implemented with other types of vehicles such as aquatic vehicles (e.g., boats, submarines, and/or the like) and ground vehicles (e.g., cars, trucks, buses, trains, and/or the like). For example, in non-limiting embodiments, a remotely-operated demining truck may be configured with a three-dimensional detection device. When the demining truck causes a land mine to explode, the cloud of dust and dirt reduce the visibility of any on-board cameras providing a visual feed to a remote operator. Thus, the three-dimensional data may be processed as described herein to create a reconstructed three-dimensional map and/or perspective for the operator of the truck even though several frames of captured data may be obscured.

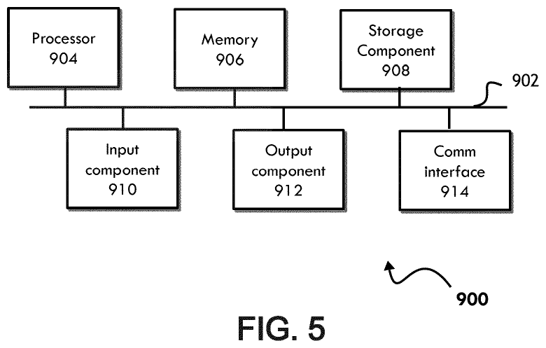

Referring now to FIG. 5, shown is a diagram of example components of a device 900 according to non-limiting embodiments. Device 900 may correspond to the computing device 106, remote server computer 118, and/or remote computing device 120 in FIG. 1, as examples. In some non-limiting embodiments, such systems or devices may include at least one device 900 and/or at least one component of device 900. The number and arrangement of components shown are provided as an example. In some non-limiting embodiments, device 900 may include additional components, fewer components, different components, or differently arranged components than those shown in FIG. 5. Additionally, or alternatively, a set of components (e.g., one or more components) of device 900 may perform one or more functions described as being performed by another set of components of device 900.

As shown in FIG. 5, device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 5, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

In specific embodiments of the invention, the method of the invention includes the following provisions.

Provision 1: A method for avoiding ground blindness in a vehicle, comprising:
capturing, with a detection device, a plurality of frames of three-dimensional data over a time period while the vehicle is approaching a landing zone, the plurality of frames of three-dimensional data representing a region associated with the landing zone;
generate a rolling point cloud map for the region by combining, with at least one processor during the time period, a subset of the plurality of frames;
determining, with the at least one processor, a ground blindness event occurring in the region during the time period;
in response to determining the blindness event occurring in the region, excluding at least one frame from the subset of the plurality of frames used to generate the rolling point cloud map for the region;
determining, with at least one processor, position data representing a position of the vehicle based on at least one sensor; and
generating, with the at least one processor, an output based on the rolling point cloud map and the position data.

Provision 2: The method of provision 1, wherein the output comprises at least one reconstructed frame of three-dimensional data generated based on the at least one frame of three-dimensional data and the subset of frames of three-dimensional data, the method further comprising replacing the at least one frame with the at least one reconstructed frame.

Provision 3. The method of provision 1, wherein the output comprises a rendered display of the region.

Provision 4. The method of provision 1, wherein the output comprises a combined display of video data of the region and the rolling point cloud map.

Provision 5. The method of provision 1, wherein the output comprises a rendering of a heads-up display or headset.

Provision 6. The method of provision 1, wherein the detection device comprises a LiDAR device, and wherein the three-dimensional data comprises LiDAR point cloud data.

Provision 7. The method of provision 1, wherein the position of the vehicle is determined with an inertial measurement unit arranged on the vehicle.

Provision 8. The method of provision 1, wherein the vehicle comprises at least one of the following vehicles: a helicopter, a drone system, an airplane, a jet, a flying taxi, a demining truck, or any combination thereof.

Provision 9. The method of provision 1, wherein the ground blindness event comprises at least one of a whiteout and a brownout.

Provision 10. The method of provision 1, wherein determining the ground blindness event occurring in the region during the time period comprises at least one of the following: automatically detecting the ground blindness event, detecting a manual user input, or any combination thereof.

In specific embodiments of the invention, the method of the invention includes the following provisions.

Provision 11. A method for avoiding ground blindness in a vehicle, comprising:
capturing, with a detection device, a plurality of frames of three-dimensional data over a time period while the vehicle is approaching a landing zone, the plurality of frames of three-dimensional data representing a region associated with the landing zone;
generating, with at least one processor, a rolling point cloud map for the region by combining, with at least one processor during the time period, a subset of the plurality of frames;
determining, with at least one processor, a ground blindness event occurring in the region during the time period;
in response to determining the ground blindness event occurring in the region, determining a position of the vehicle; and
generating, with at least one processor, at least one frame based on the position of the vehicle and at least one other frame of the plurality of frames.

Provision 12. The method of provision 11, further comprising updating the rolling point cloud map based on the at least one frame.

Provision 13. The method of provision 11, wherein generating the at least one frame comprises reconstructing obscured three-dimensional data from a captured frame based on at least one previously captured frame of the plurality of frames.

Provision 14. The method of provision 11, wherein determining the ground blindness event comprises at least one of the following: automatically detecting the ground blindness event, detecting a manual user input, or any combination thereof.

Provision 15. The method of provision 11, wherein the vehicle comprises at least one of the following aerial vehicles: a helicopter, a drone system, an airplane, a jet, a flying taxi, a demining truck, or any combination thereof.

Provision 16. The method of provision 11, wherein the position of the vehicle is determined with an inertial measurement unit arranged on the vehicle.

Provision 17. The method of provision 11, wherein the detection device comprises a LiDAR device, and wherein the three-dimensional data comprises LiDAR point cloud data.

Provision 18. The method of provision 11, further comprising generating an output based on the rolling point cloud map and the at least one frame.

Provision 19. The method of provision 18, wherein the output comprises a rendering on a heads-up display or headset.

Provision 20. The method of provision 11, wherein the ground blindness event comprises at least one of a whiteout and a brownout.

1. A method for avoiding ground blindness in a vehicle, comprising:
capturing, with a detection device, a plurality of frames of three-dimensional data over a time period while the vehicle is approaching a landing zone, the plurality of frames of three-dimensional data representing a region associated with the landing zone;
generating, with at least one processor, a rolling point cloud map for the region by combining, with at least one processor during the time period, a subset of the plurality of frames;
determining, with at least one processor, a ground blindness event occurring in the region during the time period;
in response to determining the ground blindness event occurring in the region, determining a position of the vehicle; and
generating, with at least one processor, at least one frame based on the position of the vehicle and at least one other frame of the plurality of frames.

2. The method of claim 1, further comprising updating the rolling point cloud map based on the at least one frame.

3. The method of claim 1, wherein generating the at least one frame comprises reconstructing obscured three-dimensional data from a captured frame based on at least one previously captured frame of the plurality of frames.

4. The method of claim 1, wherein determining the ground blindness event comprises at least one of the following: automatically detecting the ground blindness event, detecting a manual user input, or any combination thereof.

5. The method of claim 1, wherein the vehicle comprises at least one of the following aerial vehicles: a helicopter, a drone system, an airplane, a jet, a flying taxi, a demining truck, or any combination thereof.

6. The method of claim 1, wherein the position of the vehicle is determined with an inertial measurement unit arranged on the vehicle.

7. The method of claim 1, wherein the detection device comprises a LiDAR device, and wherein the three-dimensional data comprises LiDAR point cloud data.

8. The method of claim 1, further comprising generating an output based on the rolling point cloud map and the at least one frame.

9. The method of claim 8, wherein the output comprises a rendering on a heads-up display or headset.

10. The method of claim 1, wherein the ground blindness event comprises at least one of a whiteout and a brownout.

11. A system for avoiding ground blindness in a vehicle, comprising:
a detection device arranged on the vehicle, the detection device configured to capture a plurality of frames of three-dimensional data over a time period while the vehicle is approaching a landing zone, the plurality of frames of three-dimensional data representing a region associated with the landing zone; and
at least one processor in communication with the detection device, the at least one processor programmed or configured to:
generate a rolling point cloud map for the region by combining, with at least one processor during the time period, a subset of the plurality of frames;
determine a ground blindness event occurring in the region during the time period;
in response to determining the ground blindness event occurring in the region, determine a position of the vehicle; and
generate at least one frame based on the position of the vehicle and at least one other frame of the plurality of frames.

12. The system of claim 11, wherein the at least one processor is further programmed or configured to update the rolling point cloud map based on the at least one frame.

13. The system of claim 11, wherein generating the at least one frame comprises reconstructing obscured three-dimensional data from a captured frame based on at least one previously captured frame of the plurality of frames.

14. The system of claim 11, wherein determining the ground blindness event comprises at least one of the following: automatically detecting the ground blindness event, detecting a manual user input, or any combination thereof.

15. The system of claim 11, wherein the vehicle comprises at least one of the following aerial vehicles: a helicopter, a drone system, an airplane, a jet, a flying taxi, a demining truck, or any combination thereof.

16. The system of claim 11, wherein the position of the vehicle is determined with an inertial measurement unit arranged on the vehicle.

17. The system of claim 11, wherein the detection device comprises a LiDAR device, and wherein the three-dimensional data comprises LiDAR point cloud data.

18. The system of claim 11, wherein the at least one processor is further programmed or configured to generate an output based on the rolling point cloud map and the at least one frame.

19. The system of claim 18, wherein the output comprises a rendering on a heads-up display or headset.

20. The system of claim 11, wherein the ground blindness event comprises at least one of a whiteout and a brownout.

21. A computer-program product for avoiding ground blindness in a vehicle, comprising at least one non-transitory computer-readable medium including program instructions that, when executed by at least one processor, cause the at least one processor to:
capture a plurality of frames of three-dimensional data over a time period while the vehicle is approaching a landing zone, the plurality of frames of three-dimensional data representing a region associated with the landing zone;
generate a rolling point cloud map for the region by combining, with at least one processor during the time period, a subset of the plurality of frames;
determine a ground blindness event occurring in the region during the time period;
in response to determining the ground blindness event occurring in the region, determine a position of the vehicle; and
generate at least one frame based on the position of the vehicle and at least one other frame of the plurality of frames.
